(19) United States
(12) Patent Application Publication
(10) Pub. No.: US 2015/0346103 A1
(43) Pub. Date: Dec. 3, 2015

(54) Laser Induced Breakdown Spectroscopy (LIBS) Apparatus and Method for Performing Spectral Imaging of a Sample Surface

(71) Applicants: Sean Xiaolu Wang, Wilmington, DE (US); Qun Li, Newark, DE (US)

(72) Inventors: Sean Xiaolu Wang, Wilmington, DE (US); Qun Li, Newark, DE (US)

(73) Assignee: BWT Property, Inc., Newark, DE (US)

(21) Appl. No.: 14/723,548

(22) Filed: May 28, 2015

Related U.S. Application Data
(60) Provisional application No. 62/004,474, filed on May 29, 2014.

(51) Int. Cl. G01N 21/71; G01J 3/443

(52) U.S. Cl. CPC G01N 21/718; G01J 3/443; G01N 2201/06113

(57) ABSTRACT

This invention discloses a laser induced breakdown spectroscopy (LIBS) apparatus and method for performing spectral imaging of a sample surface. A high repetition rate pulsed laser is employed to produce a train of laser pulses. The laser beam is then scanned by a scanning mechanism over a surface of the subject sample. Each laser pulse produces a LIBS signal from a specific position of the sample surface, which is then measured by a spectrometer device to obtain a LIBS spectrum. The position of the laser beam is recorded and correlated to the corresponding LIBS spectrum. A two dimensional (2-D) mapping of the sample surface to its LIBS spectra is acquired in this manner to construct a LIBS spectral image of the sample surface.

### REFERENCE TO RELATED APPLICATION

This application claims an invention which was disclosed in Provisional Patent Application No. 62/004,474, filed May 29, 2014, entitled “LASER INDUCED BREAKDOWN SPECTROSCOPY (LIBS) APPARATUS AND METHOD FOR PERFORMING SPECTRAL IMAGING OF A SAMPLE SURFACE”. The benefit under 35 USC §119(e) of the above mentioned United States Provisional Applications is hereby claimed, and the aforementioned applications are hereby incorporated herein by reference.

### FIELD OF THE INVENTION

This invention generally relates to a laser induced breakdown spectroscopy (LIBS) apparatus and method, and more specifically to a laser induced breakdown spectroscopy (LIBS) apparatus and method for performing spectral imaging of a sample surface.

### BACKGROUND

Laser induced breakdown spectroscopy (LIBS) is a type of atomic emission spectroscopy which uses a highly energetic laser pulse as the excitation source. The laser pulse generates a high temperature micro-plasma on the surface of the sample. Microscopic particles are exploded from the surface into the plasma where they are atomized and energized. After this excitation, light that is characteristic of the elemental composition of the sample is emitted and analyzed within a spectrometer. LIBS has become a very popular analytical method in view of some of its unique features such as applicability to any type of sample, practically no sample preparation, remote sensing capability, and speed of analysis.

### SUMMARY OF THE INVENTION

It is the goal of the present invention to provide a laser induced breakdown spectroscopy (LIBS) apparatus and method for performing spectral imaging of a sample surface. A high repetition rate pulsed laser is employed to produce a train of laser pulses. The laser beam is then scanned by a scanning mechanism over a surface of the subject sample. Each laser pulse produces a LIBS signal from a specific position of the sample surface, which is then measured by a spectrometer device to obtain a LIBS spectrum. The position of the laser beam is recorded and correlated to the corresponding LIBS spectrum. A two dimensional (2-D) mapping of the sample surface to its LIBS spectra is acquired in this manner to construct a LIBS spectral image of the sample surface.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a first exemplary embodiment of the laser induced breakdown spectroscopy (LIBS) apparatus;

FIG. 2 illustrates a second exemplary embodiment of the laser induced breakdown spectroscopy (LIBS) apparatus; and

FIG. 3 shows the measured LIBS spectra of a stainless steel alloy with trace level of titanium.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a laser induced breakdown spectroscopy (LIBS) apparatus for performing spectral imaging of a sample surface. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

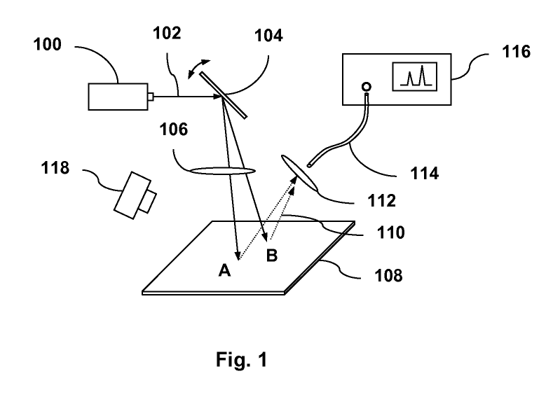

A first exemplary embodiment of the laser induced breakdown spectroscopy (LIBS) apparatus is shown in FIG. 1. The LIBS apparatus comprises a pulsed laser 100 as the excitation light source. The pulsed laser 100 is preferably a passively Q-switched diode pumped solid state (DPSS) laser, which is capable of producing a train of highly energetic laser pulses at a high repetition rate of >100 Hz, more preferably >1000 Hz. The laser beam 102 from the pulsed laser 100 is first reflected by a scanning mirror 104 and then focused by a focusing lens 106 onto a surface of the sample 108. The spot size of the laser beam on the surface of the sample is preferably on the level of a few tens of microns to obtain a high spatial resolution. The scanning mirror 104 can be a single- or dual-axis scanning Galvo mirror or a scanning micro-electro-mechanical systems (MEMS) mirror, which scans the laser beam 102 over a pre-determined angle to cause the laser beam 102 to be focused onto different positions (e.g. position A and B) of the sample 108. The laser pulse produces a plasma emission, i.e. LIBS signal 110 from the surface of the sample 108, which is collected by another focusing lens 112 to be focused into a light guide 114, such as an optical fiber bundle. The light guide 114 then delivers the LIBS signal 110 into an optical spectrometer device 116 for spectral analysis.

Referring to FIG. 1, the pulsed laser 100 produces a train of laser pulses. As the laser beam 102 is scanned over the surface of the sample 108, each laser pulse produces a LIBS signal from a specific position of the sample surface, which is then measured by the spectrometer device 116 to obtain a LIBS spectrum. The position of the laser beam on the sample surface is recorded by a camera device 118 or by recording the tilt angle of the scanning mirror 104. The position information is then correlated to the obtained LIBS spectrum in a processor to construct a two dimensional (2-D) mapping of the sample surface to its corresponding LIBS spectra.

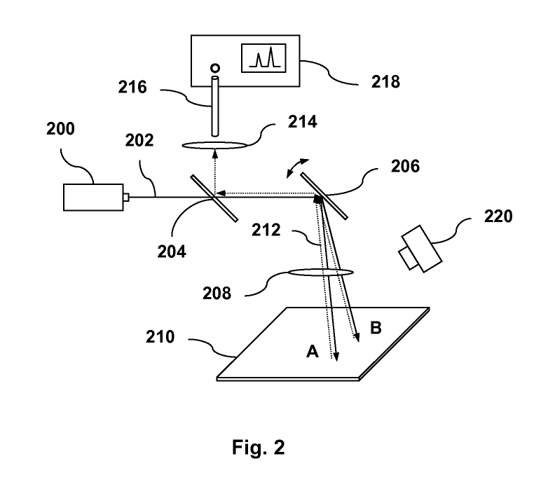

A second exemplary embodiment of the laser induced breakdown spectroscopy (LIBS) apparatus is shown in FIG. 2. The LIBS apparatus comprises a pulsed laser 200 as the excitation light source. The laser beam 202 from the pulsed laser 200 first transmits through a dichroic beam splitter 204. The laser beam 202 is then reflected by a scanning mirror 206 and focused by a focusing lens 208 onto a surface of the sample 210. The scanning mirror 206 scans the laser beam 202 over a pre-determined angle to cause the laser beam 202 to be focused onto different positions (e.g. position A and B) of the sample 210. The laser pulse produces a plasma emission, i.e. LIBS signal 212 from the surface of the sample 210, which is collected by the same focusing lens 208. The LIBS signal 212 is then reflected back by the scanning mirror 206 to the dichroic beam splitter 204, which is designed to transmit the laser beam yet reflect the LIBS signal. The reflected LIBS signal is then focused by another focusing lens 214 into a light guide 216. The light guide 218 delivers the LIBS signal 212 into an optical spectrometer device 218 for spectral analysis. The position of the laser beam on the sample surface is recorded by a camera device 220 or by recording the tilt angle of the scanning mirror 206. The position information is then correlated to the obtained LIBS spectrum in a processor to construct a two dimensional (2-D) mapping of the sample surface to its corresponding LIBS spectra.

In yet another exemplary embodiment of the present invention, the focusing lens 106 in FIG. 1 or the focusing lens 208 in FIG. 2 is mounted on a micro-motor (not shown), which causes the focusing lens to vibrate or move in a direction perpendicular to the laser beam (parallel with the sample surface). The vibration or moving pattern can be either 1-dimensional (1-D) or 2-dimensional (2-D), which results in 1-dimensional (1-D) or 2-dimensional (2-D) lateral movement of the laser beam over the sample surface. Thus the laser beam is scanned over an area of the sample surface to excite LIBS signal from multiple measurement points. The optical spectrometer device collects the LIBS signal from all these measurement points and obtains the corresponding LIBS spectra.

In yet another exemplary embodiment of the present invention, the focal point of the focusing lens 106 in FIG. 1 or the focusing lens 208 in FIG. 2 can be adjusted in a direction perpendicular to the surface of the sample. This is achieved either by moving the focusing lens in that direction or by employing a focusing lens with an adjustable focal length. As the laser pulse ablates away the surface layer of the sample, the focal point of the focusing lens is adjusted such that the laser beam is focused onto an inner layer of the sample to measure its LIBS spectrum. In this layer by layer manner, the LIBS spectra across a depth of the sample can be obtained. By combining this depth scanning with the two dimensional (2-D) scanning as taught before, a three dimensional (3-D) LIBS spectral image can be constructed for the sample.

In yet another exemplary embodiment of the present invention, instead of scanning the laser beam over the sample, the sample is moved under the laser beam, causing the laser beam to excite plasma emission from different positions of the sample surface. A spectrometer device measures the LIBS spectra of the sample for these positions. In the meantime, the position of the laser beam on the sample surface is recorded and correlated to the obtained LIBS spectrum to construct a two dimensional (2-D) LIBS spectral image of the sample surface.

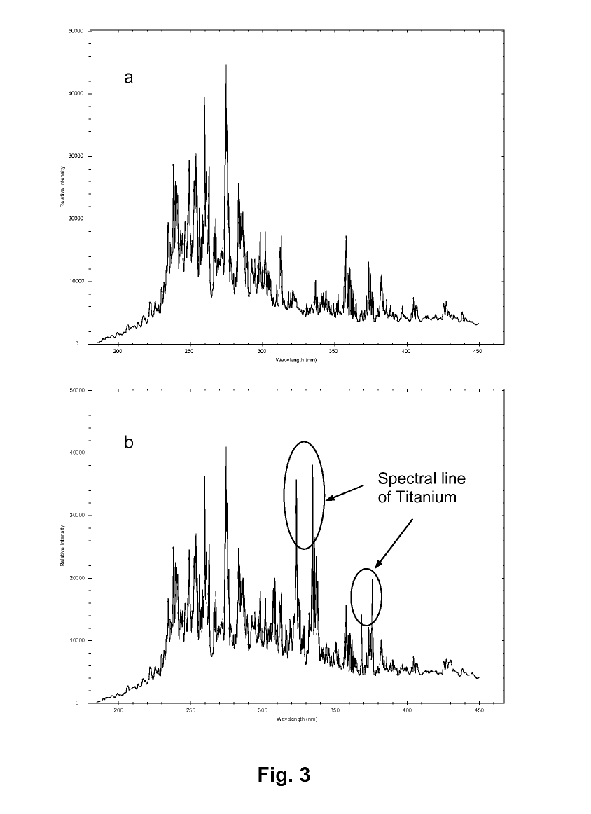

To further illustrate the concept of two-dimensional (2-D) LIBS spectral imaging, the LIBS spectrum of a stainless steel alloy sample with trace level of titanium is measured. The weight concentration of titanium in the stainless steel alloy sample is roughly 0.1%. In this example, the laser light source is a passively Q-switched Nd:YAG laser emitting at a wavelength of 1064 nm. The laser pulse energy is 20 μJ with a pulse width of 0.5 ns. The repetition rate of the laser pulse is 5 kHz. The laser spot size on the sample is 50 μm. The LIBS spectrum is measured with a CCD spectrometer covering a wavelength range of 180-450 nm. The laser beam is scanned over a surface area of roughly 4 mm² on the sample and the obtained LIBS spectrum at each measurement point is correlated to the position of the laser beam to construct a two dimensional (2-D) LIBS spectral imaging of the sample surface. Shown in FIG. 3 are the obtained LIBS spectra at two measurement points. The spectrum in FIG. 3b clearly shows the LIBS spectral lines of titanium yet such spectral lines are not observed in FIG. 3a. This indicates that the trace level of titanium is not evenly distributed in the stainless steel alloy. Instead, they form small grains on the surface of the sample. The two dimensional (2-D) LIBS spectral image clearly reveals this non-uniformity of the sample surface.

Applications of the above disclosed laser induced breakdown spectroscopy (LIBS) apparatus include but are not limited to: (a) surface analysis, such as analyzing the uniformity and distribution of certain elements under examination; (b) metallurgy property analysis, such as analyzing the grain/domain size and distribution, which have direct implication of corrosion properties, electro-chemical properties, and mechanical properties; (c) coating property analysis, such as analyzing the thickness and uniformity of the coating cross an area.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A laser induced breakdown spectroscopy (LIBS) apparatus for performing spectral imaging of a subject, the laser induced breakdown spectroscopy (LIBS) apparatus comprising:
a high repetition rate pulsed laser light source configured to produce a laser beam in the form of a train of laser pluses at a high repetition rate;
a laser beam scanner configured to scan the laser beam over an area of the subject, wherein each laser pulse of the laser beam produces a plasma emission from a specific position of the subject;
a sensor configured to monitor the position of the laser beam over the subject;
an optical spectrometer device configured to measure an optical spectrum of the plasma emission; and
a processor configured to correlate the optical spectrum of the plasma emission to the position of the laser beam to obtain a spectral image of the subject.

2. The laser induced breakdown spectroscopy (LIBS) apparatus of claim 1, wherein the repetition rate of the laser pulse is greater than 100 Hz.

3. The laser induced breakdown spectroscopy (LIBS) apparatus of claim 1, wherein the repetition rate of the laser pulse is greater than 1000 Hz.

4. The laser induced breakdown spectroscopy (LIBS) apparatus of claim 1, wherein the pulsed laser light source is a passively Q-switched diode pumped solid state (DPSS) laser.

5. The laser induced breakdown spectroscopy (LIBS) apparatus of claim 1, wherein the laser beam scanner is a Galvo mirror.

6. The laser induced breakdown spectroscopy (LIBS) apparatus of claim 1, wherein the laser beam scanner is a scanning micro-electro-mechanical systems (MEMS) mirror.

7. The laser induced breakdown spectroscopy (LIBS) apparatus of claim 1, further comprising a focusing lens configured to focus the laser beam onto the subject.

8. The laser induced breakdown spectroscopy (LIBS) apparatus of claim 7, wherein the focusing lens is mounted on a micro-motor to scan the laser beam over an area of the subject.

9. The laser induced breakdown spectroscopy (LIBS) apparatus of claim 7, wherein the focusing lens is configured to have an adjustable focal point.

10. A laser induced breakdown spectroscopy (LIBS) method for performing spectral imaging of a subject, the method comprising the steps of:
producing a laser beam in the form of a train of laser pluses at a high repetition rate;
scanning the laser beam over an area of the subject, wherein each laser pulse of the laser beam produces a plasma emission from a specific position of the subject;
monitoring the position of the laser beam over the subject;
measuring an optical spectrum of the plasma emission; and
correlating the optical spectrum of the plasma emission to the position of the laser beam to obtain a spectral image of the subject.
